(19) United States
(12) Patent Application Publication
(10) Pub. No.: US 2025/0360750 A1
(43) Pub. Date: Nov. 27, 2025

(54) POUR PAINTING APPARATUS AND METHOD

(71) Applicant: Michael Chaparro, M.D., Palm Beach Gardens, FL (US)

(72) Inventor: Michael Chaparro, M.D., Palm Beach Gardens, FL (US)

(21) Appl. No.: 18/669,927

(22) Filed: May 21, 2024

(51) Int. Cl. B44D 3/22; B44D 2/00

(52) U.S. Cl. CPC B44D 3/22; B44D 2/00

(57) ABSTRACT

An apparatus and method for constructing large and reproduceable pour paintings. The apparatus consists of a support frame for holding a square or rectangular paintable element in a horizontal plane. A pulley mechanism is secured to each corner of the paintable element which allows the individual corner to be raised or lowered thereby inducing a tilt of the paintable element. In a basic embodiment, each corner may be manually raised or lowered to a predetermined position as a first color is placed on the paintable element. Additional colors can then be placed on the paintable element as additional tilting is induced. These steps can be repeated until the paintable element is coated according to the design of the artist.

### FIELD OF THE INVENTION

The field of this invention is related to artistic painting and, in particular, to an apparatus and method that facilitates large scale pour paintings.

### BACKGROUND OF THE INVENTION

Pour painting is commonly known to be an abstract art form that results in vibrant and unpredictable patterns. The technique is performed by an artist who pours different colors of paint onto a canvas and then tilts the canvas to allow the paint to flow creating unique patterns. The pouring of different colors and quantities of paint, at different times, onto a canvas backing element and tilting the paintable element by lifting one or more edges can result in spectacular color patterns. Each color can be poured directly onto the paintable element forming layers of paint and various pouring techniques results in unique patterns. Once a pattern has been placed on the canvas, the paint is allowed to dry and the resulting painting is then clear coated to protect the artwork.

What is lacking in the field is an apparatus and method to make: large scale abstract pour paintings, abstract pour paintings with closely repeatable patterns, or an apparatus constructed and arranged to create paintings wherein sectionals cut from the painting can be used in cabinet inlays wherein the pattern between cabinet inlays would appear to be continuous.

### SUMMARY OF THE INVENTION

An apparatus and method for constructing large scale reproduceable pour paintings. The apparatus consists of a support frame for positioning a large square or rectangular paintable element in a horizontal plane. A lift mechanism is secured to each corner of the paintable element which allows the corner to be raised or lowered a predetermined amount to induce a tilt of the paintable element. In one embodiment, each corner is raised or lowered, through a pulley arrangement, to a predetermined position and liquid paint of a first color is placed on the paintable element. Additional colors can then be placed on the paintable element as tilting of various corners is induced. These steps can be repeated until the paintable element is coated according to a design valued by the artist. By recording the color of paint, quantity of paint, time and tilt angle, a pour painting can be reproduced to substantially the same pattern by following the same steps. This is especially useful when a consumer requests a particular painting to be reproduced yet requires an original painting. The tilting of the paintable element by the lift mechanism includes using pulleys to accommodate the weight of the paintable element by proper pulley orientation. In another embodiment, the tilting can be accomplished through stepper motors wherein a programmable logic controller PLC controlled by an external computer can be repeat the tilting of the paintable element to match a previously recorded pattern.

In an application embodiment, the large paintable element is painted, dried, and then cut into panel inlays. The panel inlays are arranged to reconnect forming a continuous pattern. A consumer can request a builder to reproduce a pour paint arrangement should they request a similar design.

An objective of the invention is to provide an apparatus for making large pour paintings from paintable elements.

Yet another objective of the invention is to provide an apparatus for reproducing pour paintings wherein the paintable element can be tilted to predetermined angles that match a preexisting pattern.

Still another objective of the invention is to provide an apparatus that allows an artist to construct a pour painting of any size or weight wherein the weight of the painting element is offset by the use of counterweight pulleys, motors, or the like.

Yet another objective of the invention is to provide an apparatus that allows pour painting of large pieces of glass, wood or the like materials.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE DRAWINGS

The present invention is illustrated and described herein with reference to the various drawings, in which like reference numbers are used to denote like system components/method steps, as appropriate, and in which:

FIG. 1 is a perspective side view of a pour painting apparatus;

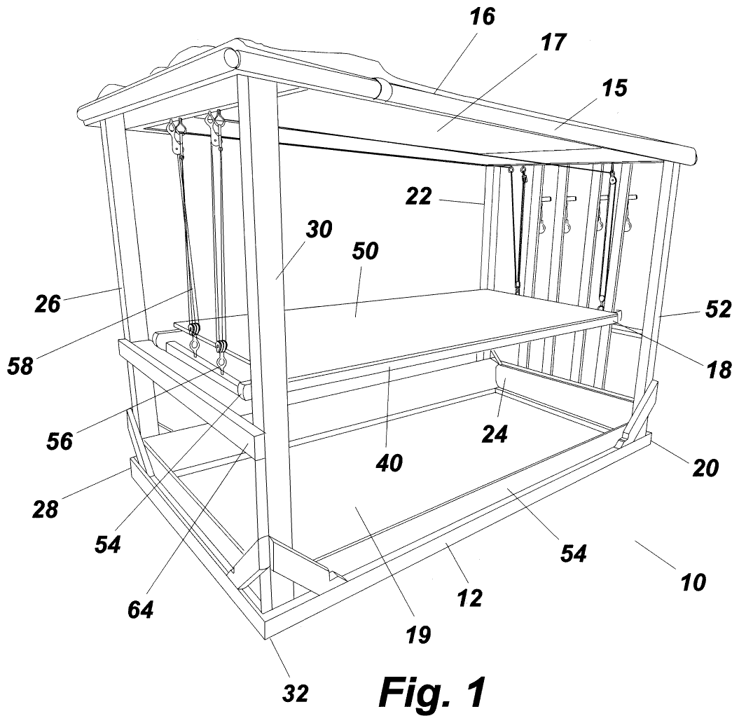

FIG. 2 is a front view of the pour painting apparatus;

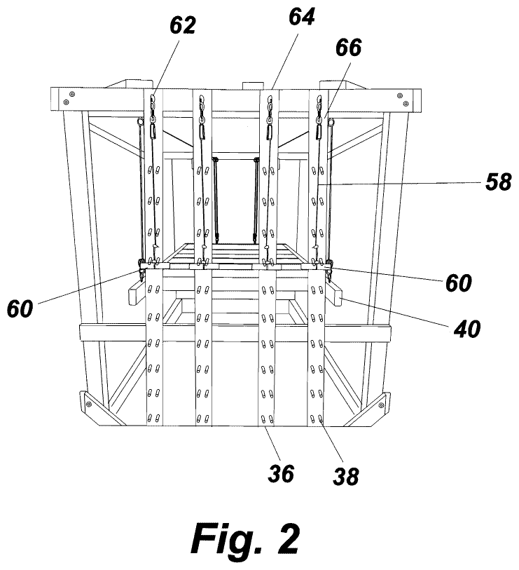

FIG. 3 is a perspective front view of the pour painting apparatus;

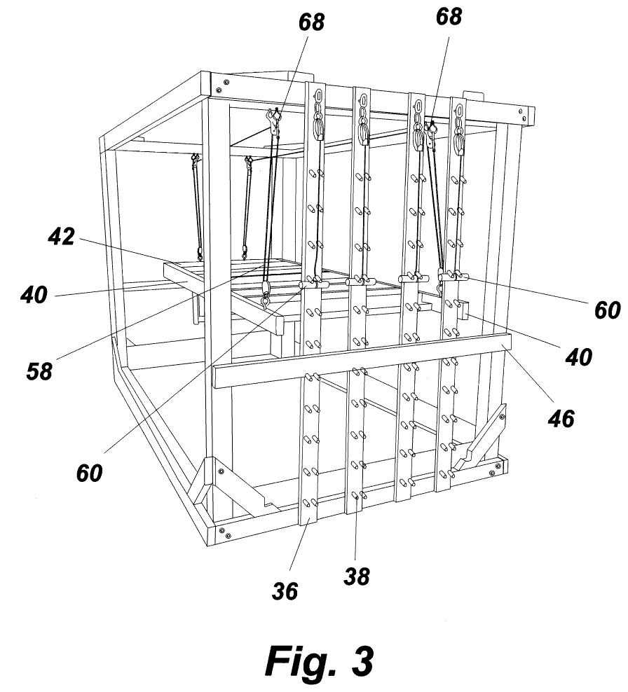

FIG. 4 is a perspective top view of the pour painting apparatus with a paintable element;

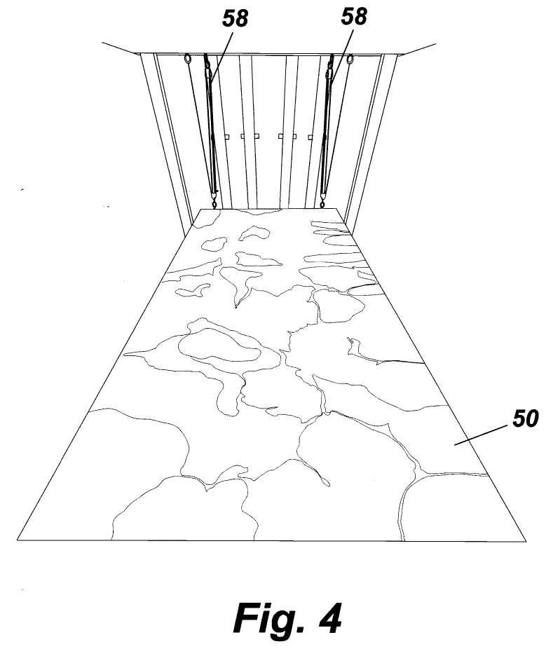

FIG. 5 is a perspective front view of the pour painting apparatus with a programmable logic controller PLC controlled by an external computer; and

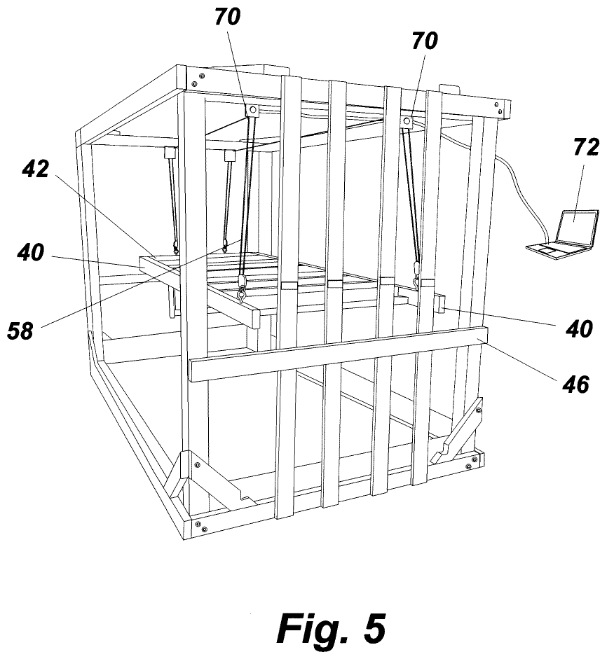

FIG. 6 is a perspective view of a kitchen with continuous cabinet inlays.

### DETAILED DESCRIPTION OF THE PREFERRED EMBODIMENT

Detailed embodiments of the instant invention are disclosed herein; however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

Disclosed is an apparatus and method for constructing large and substantially reproduceable pour paintings. In a particular application embodiment, cabinet inlays can be produced that employ abstract pour painting designs cut from a single pour painting when the paintable element is wood or canvas. The adjoining cabinets present a continuous flow of the single pour painting.

For purposes of this specification, the term “paintable element” can refer to canvas, wood, glass, metal plastic, or stone. The pour painting technique can be summarized by the following steps: Position a movable platform in a horizontal plane. Attach a lift mechanism to each corner of the movable platform, each corner of the movable platform movable in predetermined increments by the lift mechanism. Secure a paintable element to an upper surface of the movable platform. Pour paint of a first color onto the paintable element. Tilt the movable platform by adjusting one or more lift mechanisms. Pour paint of a second color onto the paintable element and cause a tilting of the paintable element by adjusting one or more lift mechanisms. Repeat the step of pouring of paint using a different color and inducing tilting of the movable platform by lifting or lowering one or more corners of the movable platform until the paintable element is coated. Dry the paint placed on the paintable element. Coating the painted canvas with a varnish, epoxy, acrylic, or the like clear coating to protect and enhance the paint colors. Cut the paintable element into sections and reassembly onto cabinet inlays, or another background, to resurrect the paintable element into a pattern that resembles the paintable element before the step of cutting. By tilting the movable platform and paintable element in different directions, the paint is allowed to flow and mix to create unique patterns. With the ability to move each corner of the movable platform by predetermined amounts, patterns can be repeated by tracking tilt angles, paint color, painting amount, and timing. By placing a reusable or disposable drop sheet beneath the movable platform, excess paint that exceeds the paintable element can be easily disposed of.

Now referring to the Figures, a pour painting apparatus 10 is shown. The pour painting apparatus 10 is sized to hold large or small paintable elements for pour paintings. The apparatus 10 includes a frame 12 having a lower base member 14 spaced apart from an upper support member 16 by a first post 18 secured to a first corner 20 of the lower base member 14 and the upper support member 16. Further, the frame 12 includes a second post 22 secured to a second corner 24, a third post 26 secured to a third corner 28, and a fourth post 30 secured to a fourth corner 32. In a preferred embodiment, the lower base member 14 and the upper support member 16 are substantially rectangular in shape.

The posts 18, 22, 26, 30 may extend from the lower base member 14 to the upper support member 16 in a substantially perpendicular direction but may taper outwardly from the lower base member 14 so that the size of the upper support member 16 is larger than the lower base member 14. In an alternative embodiment, the posts 18, 22, 26, 30 may extend from the lower base member 14 to the upper support member 16 in a substantially perpendicular direction but may taper inwardly from the lower base member 14 so that the upper support member 16 is smaller than the lower base member 14. Further, the posts 18, 22, 26, 30 may extend from the lower base member to the upper support member 16 in a perpendicular direction so that the size of the upper support member 16 is equivalent to the size of the lower base member 14. The length of the posts 18, 22, 26, 30 is not limiting. Likewise, the size and shape of the lower base member 14 and the upper support member 16 is not limiting.

Pour paintings, small or large, are typically heavy due to the amount of paint employed and the frame 12 provides a means to support and maneuver heavy paintable elements. Even canvas, while light in comparison to stone, can be too heavy or awkward for a single individual to manually tilt the canvas without paint, wherein the addition of paint weighing between 7 and 12 pounds per gallon can tax any movement of the paintable element. Maintaining the paintable element in a fixed position while drying is critical to assure the flow does not continue. To ensure that the frame 12 can support heavy weight, the frame 12 includes cross bracings 34 disposed at each corner 20, 24, 28, 32 of the frame 12 to reinforce the lower base member 14 to each post 18, 22, 26, 30. The cross bracings 34 may be secured with bolts, screws, or other fasteners. The size, shape, and number of cross bracings 34 are not limiting. Roll drapes 15 may be deployed after to inhibit airborne dust from gathering on the paintable element 50 during the curing stage. Similarly, a top cover 17 may encompass the upper support member 16 to protect the paintable element 50. A disposable bottom tarp, not shown, can be placed over the base 19 to catch excess paint that may drop from the paintable element 50.

The frame 12 includes at least four vertical slats 34 extending from the lower base member 14 to the upper support member 16 disposed between two of the posts 18, 22, 26, 30. Each vertical slat 36 has a plurality of handle pegs 38 extending outwardly therefrom. In a preferred embodiment, the handle pegs 36 on each vertical slat 36 are aligned horizontally. The size, shape, and number of vertical pegs 38 on the vertical slats 34 are not limiting.

In a typical scenario, a paintable element is placed on a movable platform 40 positioned within the frame 12 formed from a lateral support beam 42 extending from a lower surface 44 of the platform 40 disposed approximately central between a front end 46 and a rear end 48 of the movable platform 40 and extending a length 51 between a proximal end 52 and a distal end 54. The lateral support beam 42 has a cable anchor 56 disposed at the proximal end 52 and at the distal end 54 supporting cables 58 directed to the cable anchors 56 disposed on the lower surface 44 of the movable platform 40 forming a lift mechanism. The purpose of the lateral support beam 42 attached to cables 58 forming a lift mechanism is to properly distribute the weight of the movable platform and any paintable element place thereon. The cables 48 work similar to a truss, evenly distributing the weight across the entire movable platform 40.

The cables 58 need to retain tension and the amount of tension can be adjusted with a turn buckle 68 that is disposed along the cables 58. In a preferred embodiment, the turn buckle 68 is disposed on the cables 58 directed towards the cable anchors 56 disposed on the lower surface 44 of the movable platform 40. The turn buckle 68 is placed in this location for easy access to adjust the cable tension as well as adjusting the position of the movable platform 40, if needed. The turn buckle 68 and cables 58 are designed to prevent the platform 40 from sagging in the middle. The turn buckle 68 can be further adjusted to accommodate the weight of the material and ensure that the platform 40 remains straight.

The movable platform 40 within the frame 12 of the pour painting apparatus 10 is fully adjustable as it is suspended by cables 48. In order to adjust the height and tilt of the movable platform 40, a plurality of handles 60 connected to cables 58 are disposed on the outside surface of each vertical slat 36 and are removably secured to any one of the handle pegs 38. The cables 58 are constructed and arranged to pass through an aperture 62 located on an upper end 64 of the vertical slats 36 and directed towards a plurality of pulley mechanisms 66 secured to each corner of the movable platform 40.

Although the direction of the cables 58 is not limiting, in the disclosed embodiment, the leftmost and rightmost handles 60 correspond to the movement of the front end 46 of the movable platform 40 and the two innermost handles 60 correspond to the movement of the rear end 48 of the movable platform 40. The cables 58 running from the handles 60 passes through an aperture 62 and is directed towards each pulley mechanism 66 whereby the pulley mechanism 66 allows each corner of the movable platform 40 to be raised and lowered independently to induce tilting of said movable platform 40. Simply by moving the handle 60 down and placing it within another handle peg 38, the tilt of the movable platform 40 is adjusted. In an alternative embodiment, the tilting can be accomplished through stepper motors 70 wherein a programmable logic controller PLC controlled by an external computer 72 can be repeat the tilting of the paintable element to match a previously recorded pattern.

The frame 12 of the pour painting apparatus 10 may include horizonal reinforcement bars 64 connecting the posts 18, 22, 26, 30 on a front end and a rear end of the frame 12 disposed at a height between the lower base member 14 and the upper support member 16. The horizontal reinforcement bars 64 provide a limit of range to which said movable platform 40 may be lowered considered a horizontally level plane. The horizontal reinforcement bars 64 also prevents the movable platform 40 from catastrophically failing and falling to the floor.

In a preferred embodiment, the paintable element is first placed onto the movable platform 40 in a horizonal position. An artist may determine the tilt necessary when adding a first color onto the paintable element. Additional colors can then be placed on the canvas as additional tilting is induced. These steps can be repeated until the paintable element is coated according to the design of the artist. By recording the color of paint, quantity of paint, time and tilt angle, a pour painting can be reproduced to substantially the same pattern, by following the same steps. The pour painting is typically left out to dry, and later coated with varnish, epoxy, acrylic, or the like clear coating to protect and enhance the paint colors.

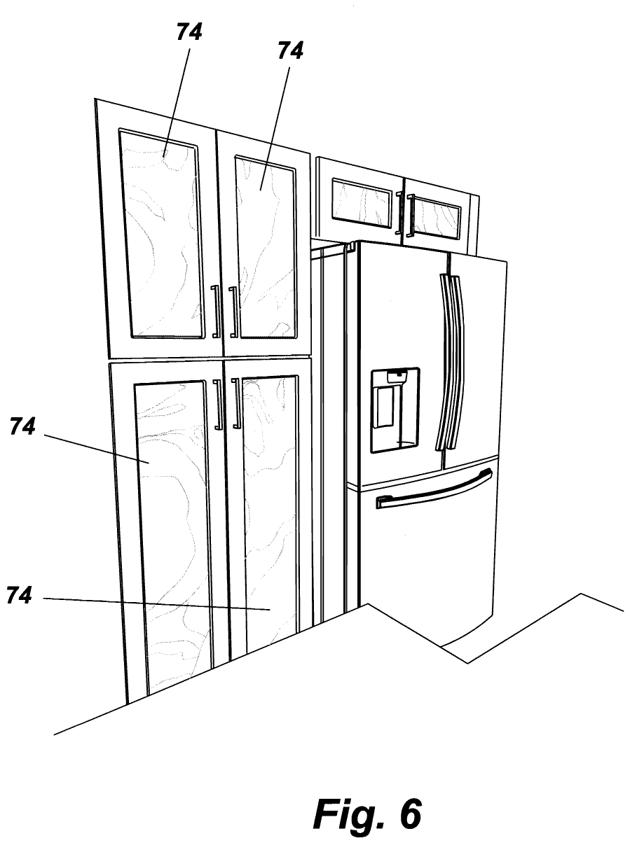

In one application embodiment, the paintable element is wood which is pour painted and then cut into panel inlays. In another embodiment, the paintable element is canvas which is pour painted and then used as panel inserts, as shown in FIG. 6. The pour painting is preferably large enough for use in making continuous cabinet inlays 74 from a single pour painting. A builder can reproduce the paint arrangement should another customer request a similar design, yet the reproduced pour painting will be an original.

One skilled in the art will readily appreciate that the present invention is well adapted to carry out the objectives and obtain the ends and advantages mentioned, as well as those inherent therein. The embodiments, methods, procedures, and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

The use of the word “a” or “an” when used in conjunction with the term “comprising” in the claims and/or the specification may mean “one,” but it is also consistent with the meaning of “one or more” or “at least one.” The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

What is claimed is:

1. A pour painting apparatus for constructing large and reproduceable pour paintings comprising:
a frame formed from a lower base member spaced apart from a upper support member by a first post secured to a first corner of said lower base member and said upper support member, a second post secured to a second corner of said lower base member and said upper support member, a third post secured to a third corner of said lower base member and said upper support member, and a fourth post secured to a fourth corner of said lower base member and said upper support member;
at least four vertical slats extending from said lower base member to said upper support member disposed between two of said posts, each said vertical slat having a plurality of handle pegs extending outwardly therefrom;
a movable platform positioned within said frame formed from a lateral support beam extending from a lower surface of said platform disposed approximately central between a front end and a rear end of said movable platform and extending a length between a proximal end and a distal end, said lateral support beam having a cable anchor disposed at said proximal end and said distal end supporting cables directed to cable anchors disposed on said lower surface of said movable platform forming a lift mechanism, said movable platform constructed and arranged to receive paintable element; and
a plurality of handles connected to cables disposed on an outside surface of each of said plurality of vertical slats and removably secured to any one of said handle pegs, said cables c pass through an aperture located on an upper end of said vertical slats and directed towards a plurality of pulley mechanisms secured to each corner of said movable platform,
whereby said pulley mechanism allows each said corner of said movable platform to be raised and lowered independently to induce tilting of said movable platform.

2. The pour painting apparatus according to claim 1 including horizonal reinforcement bars connecting said posts on a front end and a rear end of said frame disposed at a height between said lower base member and said upper support member wherein said horizontal reinforcement bars provide a limit of range to which said movable platform may be lowered to a fixed horizontally plane.

3. The pour painting apparatus according to claim 1 including a turn buckle disposed along said cables directed to said cable anchors disposed on said lower surface of said movable platform for adjusting the position of said movable platform.

4. The pour painting apparatus according to claim 1 including cross bracings disposed at each corner of said support frame reinforcing the attachment of each post to said lower base member.

5. The pour painting apparatus according to claim 1 wherein said lower base member and said upper support member are substantially rectangular in shape.

6. The pour painting apparatus according to claim 1 wherein upper support member is larger than said lower base member whereby said posts are angled outwardly from said lower base member to support said upper support member.

7. The pour painting apparatus according to claim 1 wherein the tilting of said movable platform can be accomplished through stepper motors wherein a programmable logic controller PLC can be repeat the tilting of the pour painting canvas to match a previously recorded pattern.

8. A pour painting apparatus for constructing large and reproduceable pour paintings comprising:
a frame formed from a lower base member spaced apart from a upper support member by a first post secured to a first corner of said lower base member and said upper support member, a second post secured to a second corner of said lower base member and said upper support member, a third post secured to a third corner of said lower base member and said upper support member, and a fourth post secured to a fourth corner of said lower base member and said upper support member, said upper support member is larger than said lower base member whereby said posts are angled outwardly from said lower base member to support said upper support member;
at least four vertical slats extending from said lower base member to said upper support member disposed between two of said posts, each said vertical slat having a plurality of handle pegs extending outwardly therefrom;
a movable platform positioned within said frame formed from a lateral support beam extending from a lower surface of said platform disposed approximately central between a front end and a rear end of said movable platform and extending a length between a proximal end and a distal end, said lateral support beam having a cable anchor disposed at said proximal end and said distal end supporting cables directed to cable anchors disposed on said lower surface of said movable platform forming a lift mechanism, said movable platform constructed and arranged to receive a paintable element; and
a plurality of handles connected to cables disposed on an outside surface of each of said plurality of vertical slats and removably secured to any one of said handle pegs, said cables constructed and arranged to pass through an aperture located on an upper end of said vertical slats and directed towards a plurality of pulley mechanisms secured to each corner of said movable platform,
whereby said pulley mechanism allows each said corner of said movable platform to be raised and lowered independently to induce tilting of said movable platform.

9. The pour painting apparatus according to claim 8 including horizonal reinforcement bars connecting said posts on a front end and a rear end of said frame disposed at a height between said lower base member and said upper support member wherein said horizontal reinforcement bars provide a limit of range to which said movable platform may be lowered considered a horizontally level plane.

10. The pour painting apparatus according to claim 8 including a turn buckle disposed along said cables directed to said cable anchors disposed on said lower surface of said movable platform for adjusting the position of said movable platform.

11. The pour painting apparatus according to claim 8 including cross bracings disposed at each corner of said support frame reinforcing the attachment of each post to said lower base member.

12. The pour painting apparatus according to claim 8 wherein said lower base member and said upper support member are substantially rectangular in shape.

13. The pour painting apparatus according to claim 8 wherein the tilting of said movable platform can be accomplished through stepper motors wherein a programmable logic controller PLC can be repeat the tilting of the paintable element to match a previously recorded pattern.

14. A method for pour painting using a pour painting apparatus comprising the steps of:
positioning a paintable element on a movable platform, said movable platform having a lift mechanism formed from an adjustable cable attached to each corner of said movable platform, said lift mechanism coupled to an upper frame positioning said movable platform over said drop sheet;
pouring paint of a first color onto said paintable element and causing a tilting of said paintable element by lifting or lowering one or more edges by said lift mechanism;
pouring paint using different colors and inducing further tilting of said paintable element by lifting or lowering of more edges by said lift mechanism until said paintable element is coated; and
drying said paints.

15. The method according to claim 14 further comprising the steps of:
cutting said paintable element into sections; and
attaching said sections into cabinet inlays.

16. The method according to claim 14 further comprising the steps of:
tilting said paintable element by said lift mechanism into different directions to allow the paint to flow and mix to create unpredictable patters;
drying said painted paintable element; and
coating said painted canvas with a varnish, epoxy, acrylic, or the like clear coating to protect and enhance the paint colors.
